(19) United States
(12) Patent Application Publication
(10) Pub. No.: US 2022/0029462 A1
(43) Pub. Date: Jan. 27, 2022

(54) FAR-FIELD WIRELESS POWER TRANSFER USING LOCALIZED FIELD WITH MULTI-TONE SIGNALS

(71) Applicant: HUAWEI TECHNOLOGIES CO.,LTD., Shenzhen (CN)

(72) Inventors: Songnan Yang, Plano, TX (US); Ning Pan, Dongguan (CN)

(73) Assignee: HUAWEI TECHNOLOGIES CO.,LTD., Shenzhen (CN)

(21) Appl. No.: 17/497,934

(22) Filed: Oct. 9, 2021

Related U.S. Application Data
(63) Continuation of application No. PCT/US2020/027150, filed on Apr. 8, 2020.
(60) Provisional application No. 62/831,570, filed on Apr. 9, 2019.

(51) Int. Cl. H02J 50/20; H04B 7/06; H02J 50/40; H02J 50/80; H02J 7/00

(52) U.S. Cl. CPC H02J 50/20; H04B 7/0617; H02J 7/00034; H02J 50/80; H02J 50/402

(57) ABSTRACT

Techniques and apparatus are described for use in far-field wireless power transmitter. A far-field wireless power transmitter uses beamforming to localize a power signal transmitted from an array of antenna. A multi-tone signal is used for the power signal, where the signal transmitted from each of the antenna is formed of a plurality of tones having a frequency center and separated by a uniform frequency difference, and relative delays and/or relative amplitude differences are introduced into the signals from the different antennas of the array so that a beam is formed in a region where a far-field wireless power receiver's antenna is located. By use of two such transmitters placed to either side of the receiver, a hot-spot for the multi-tone power signal can be formed in the region of the receiver's antenna, with lower field values away from the region.

### CROSS-REFERENCE TO RELATED APPLICATIONS

This application is a continuation of International Application No. PCT/US2020/027150, filed on Apr. 8, 2020, which claims priority to U.S. Provisional Appl. No. 62/831,570 entitled “METHOD TO CREATE LOCALIZED FIELD WITH MULTI-TONE SIGNALS IN FARFIELD WIRELESS POWER TRANSFER”, filed Apr. 9, 2019, by Yang et al. All of the aforementioned patent applications are hereby incorporated by reference in their entireties.

### TECHNICAL FIELD

The disclosure generally relates to wireless power transfer systems and methods for use therewith.

### BACKGROUND

Wireless power transfer (WPT) finds a number of applications in battery charging and powering various electronic devices. Most current wireless charging or power transfer systems are near field systems that rely upon transferring power though the magnetic coupling of a coil on the power transmitter and a coil on the power receiver. A practical far-field wireless power transfer technology would be of great utility, as this would enable a wireless experience for powering and charging devices. However, a significant drawback of the current methods of far-field wireless power transfer is that while they send energy from a transmitter to the receiver by creating a field or vibration at the receiver location, it also creates strong fields along the path between transmitter and the receiver. This field is usually stronger than the field at the receiver location, which creates safety and interference concerns.

### SUMMARY

According to a first aspect of the present disclosure, a wireless power transmitter includes a beamformer and a first array of a plurality antennas. The beamformer configured to: generate a multi-tone power signal formed of a plurality of tones having a frequency center and separated by a uniform frequency difference and generate from the multi-tone power signal a first plurality of multi-tone power signals configured to form a beam at a first location. The first array of a plurality antennas connected to the beamformer, each of the antennas of the first array configured to receive and transmit one of the first plurality of multi-tone power signals.

Optionally, in a second aspect and in furtherance of the first aspect, each the first plurality of multi-tone power signals has a corresponding relative phase difference configured to form a beam at the first location.

Optionally, in a third aspect and in furtherance of the second aspect, each the first plurality of multi-tone power signals has a corresponding relative amplitude difference configured to form a beam at the first location.

Optionally, in a fourth aspect and in furtherance of the third aspect, the one or more control circuits connected to the beamformer and configured to determine the corresponding relative phase differences and relative amplitude differences for first plurality of the multi-tone power signals.

Optionally, in a fifth aspect and in furtherance of the fourth aspect, the wireless power transmitter further includes a communication antenna connected to the one or more control circuits, the one or more control circuits further configured to exchange signal with a wireless power receiver over the communication antenna and determine the corresponding delays relative phase differences and relative amplitude differences for the first plurality of multi-tone power signals based upon signals exchanged with the wireless power receiver.

Optionally, in a sixth aspect and in furtherance of the fifth aspect, the one or more control circuits are further configured to determine the corresponding relative phase differences and relative amplitude differences based upon signals exchanged with the wireless power receiver so that the transmitted first location is a location of the wireless power receiver.

Optionally, in a seventh aspect and in furtherance of the sixth aspect, the one or more control circuits are configured to determine the relative phase differences and relative amplitude differences by a channel estimation.

Optionally, in an eighth aspect and in furtherance of the third to seventh aspects a second array of a plurality antennas connected to the beamformer, wherein the beamformer is further configured to generate a second plurality of multi-tone power signals and introduce a corresponding relative phase differences and relative amplitude differences into each of the second plurality of multi-tone power signals, and wherein each of the antennas second array are configured to receive and transmit one of the second plurality of multi-tone power signals.

Optionally, in a ninth aspect and in furtherance of any preceding aspect, the one or more control circuits connected to the beamformer and configured to determine corresponding delays relative phase differences and relative amplitude differences for the first plurality of multi-tone power signals configured to thereby form a beam at a first location.

Optionally, in a tenth aspect and in furtherance of any preceding aspect, the frequency center is the radio frequency (RF) range.

Optionally, in an eleventh aspect and in furtherance of any preceding aspect, the uniform frequency difference in a range of 10 MHz to 50 MHz.

According to one other aspect of the present disclosure, a method of wirelessly transferring power includes generating a first set of multiple copies of a multi-tone power waveform by a first wireless power transmitter. The method also introducing by the first wireless power transmitter of a first set of relative delays into the first set of copies of the multi-tone power waveform, the first set of relative delays configured to form a beam when the first set of copies of the multi-tone power waveform is transmitted from a first array of antennas. The method further includes transmitting the first set of copies of the multi-tone power waveform with the first set of relative delays from first array.

According to another aspect of the present disclosure, a wireless power transfer system includes a first wireless power transmitter and a second wireless power transmitter. The first wireless power transmitter includes: a first signal generation and optimization circuit configured generate a first plurality of multi-tone beam forming waveforms; and a first antenna array connected to the first signal generation and optimization and configured to receive and transmit the first plurality of multi-tone beam forming waveforms. The second wireless power transmitter includes: a second signal generation and optimization circuit configured generate a second plurality of multi-tone beam forming waveforms; and a second antenna array connected to the second signal generation and optimization and configured to receive and transmit the second plurality of multi-tone beam forming waveforms. The first signal generation and optimization circuit and the second signal generation and optimization circuit are further configured to respectively generate the first plurality of multi-tone beam forming waveforms and the second plurality of multi-tone beam forming waveforms to constructively interfere at a region located between the first wireless power transmitter and the second wireless power transmitter.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures.

FIG. 1 illustrates an example wireless battery charging system.

FIG. 2 is a block diagram for one embodiment of a far-field wireless power transmitter and a far-field wireless power receiver.

FIGS. 3A and 3B illustrate a simulation of a 2D field distribution from an 8 antenna element array transmitting RF signals at the same single frequency, equal amplitude and in phase.

FIG. 4A shows the time domain waveform of an embodiment of a multi-tone signal consisted of 8 equally spaced, in phase tones centered at 2.45 GHz with 20 MHz spacing between the tones.

FIG. 4B is a plot showing at one instance of time the field established by a multi-tone signal over points along the propagation path different distances from the source.

FIGS. 5A-5C show a two-dimensional simulation of wave propagation from an 8 antenna beamforming transmitter.

FIG. 5D illustrates the peak field strength for the same simulation as represented in FIGS. 5A-5C.

FIG. 6 illustrates an embodiment that uses two beamforming far-field wireless power transmitters to transmit power to a far-field wireless power receiver.

FIGS. 7A and 7B illustrate 2D simulations similar to FIGS. 5A-5C, but with two far-field beamforming wireless power transmitters using multi-tone power signals to either side of the region.

FIG. 7C is a peak field strength for the same simulation as represented in FIGS. 7A and 7B.

FIG. 7D is a plot of peak field strength for the same simulation of FIG. 7C, but where the two multi-tone waves of the power are transmitted with different delay and beam steering angle to achieve a “hot spot” off centerlines.

FIG. 8 illustrates an environment where strong reflection occurs at the boundary of the domain and where, in some embodiments, the reflection from the boundary can be utilized to form localized “hot spots”.

FIG. 9 illustrates a general case in which a domain with strong reflecting boundaries (such as a room with metal walls) has multiple reflections of the same power signal.

FIG. 10 is a flowchart of one embodiment of a process of operating a far-field wireless power transmitter using a multi-tone power signal.

FIG. 11 is a flowchart of one embodiment of a process of operating far-field wireless power transmitters using a multi-tone power signals in a multiple sub-array or multiple transmitter embodiment as in FIG. 6.

FIGS. 12 and 13 are respectively flowcharts of embodiments for receiver initiated and transmitter initiated channel estimation.

### DETAILED DESCRIPTION

The present disclosure will now be described with reference to the figures, which in general relate to far-field wireless power transfer by use of one or more beamforming transmitters to create a localized field from a multi-tone signal.

Far-field wireless power transfer is considered the “holy grail” of wireless power technologies as it would enable a Wi-Fi like user experience for powering and charging devices. It usually employs a type of wave, such as electromagnetic (radio frequency, or RF, and microwave) or mechanical (ultrasound), to carry the energy from the transmitter to a receiver more than a few wavelengths away (i.e. in the far-field). An array of more than one antenna or transducers can be used to “form a beam” to direct energy from a transmitter to the receiver, leveraging the array gain to overcome the path losses. However, a significant drawback of such methods of typical beamforming is that while it sends energy from a transmitter to the receiver by creating a field/vibration at the receiver location, it also creates strong fields along the path between the transmitter and receiver. This field is usually stronger at points along the path than the field at the receiver location, which creates safety and interference concerns.

The following presents embodiments that employ multi-tone signals for power transfer and leverage its time domain characteristics to localize the strongest field in a designated location in space through strategic placement of wireless power transmitters and optimized beamforming techniques. The antenna array size, bandwidth and frequency spacing between the multi-tone signals can be selected for a certain operating environment to realize this localized field, which will in turn lead to a far-field wireless power transfer solution with significantly less RF exposure risk and regulatory concerns.

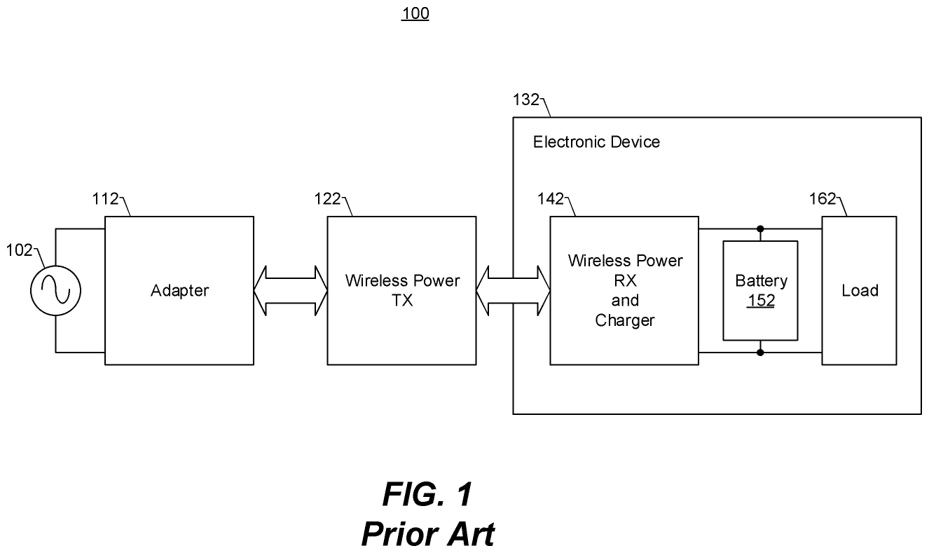

FIG. 1 is a block diagram of an example wireless battery charging system 100 that can be used illustrate some of the basic elements commonly found in such systems. Referring to FIG. 1, the example wireless battery charging system 100 is shown as including an adaptor 112, a wireless power transmitter (TX) 122, and a wireless power receiver (RX) and charger 142. As can be appreciated from FIG. 1, the wireless power RX and charger 142 is shown as being part of an electronic device 132 that also includes a rechargeable battery 152 and a load 162 that is powered by the battery 152. Since the electronic device 132 is powered by a battery, the electronic device 132 can also be referred to as a battery-powered device 132. The load 162 can include, e.g., one or more processors, displays, transceivers, and/or the like, depending upon the type of the electronic device 132. The electronic device 132 can be, for example, a mobile smartphone, a tablet computer, or a notebook computer, but is not limited thereto. The battery 152, e.g., a lithium-ion battery, can include one or more electrochemical cells with external connections provided to power the load 162 of the electronic device 132.

The adaptor 112 converts an alternating current (AC) voltage, received from an AC power supply 102, into a direct current (DC) input voltage (Vin). The AC power supply 102 can be provided by a wall socket or outlet or by a power generator, but is not limited thereto. The wireless power TX 122 accepts the input voltage (Vin) from the adaptor 112 and in dependence thereon transmits power wirelessly to the wireless power RX and charger 142. The wireless power TX 122 can be electrically coupled to the adaptor 112 via a cable that includes a plurality of wires, one or more of which can be used to provide the input voltage (Vin) from the adaptor 112 to the wireless power TX 122, and one or more of which can provide a communication channel between the adaptor 112 and the wireless power TX 122. The communication channel can allow for wired bi-directional communication between the adaptor 112 and the wireless power TX 122. The cable that electrically couples the adaptor 112 to the wireless power TX 122 can include a ground wire that provides for a common ground (GND). The cable between the adaptor 112 and the wireless power TX 122 is generally represented in FIG. 1 by a double-sided arrow extending between the adaptor 112 and the wireless power TX 122. Such a cable can be, e.g., a universal serial bus (USB) cable, but is not limited thereto.

The wireless power RX and charger 142 receives power wirelessly from the wireless power TX 122 and uses the received power to charge the battery 152. In a typical near-field wireless power transfer system, the power transfer between the wireless power RX 142 and the wireless power TX 122 is via an inductive coupling of coils on the wireless power RX 142 and the wireless power TX 122. The embodiments discussed below are far-field power transfer systems using a beamforming wireless power TX 122 and multi-tone RF power signals. The wireless power RX and charger 142 may also wirelessly communicate bi-directionally with the wireless power TX 122. In FIG. 1 a double-sided arrow extending between the wireless power TX 122 and the wireless power RX and charger 142 is used to generally represent the wireless transfer of power and communications therebetween.

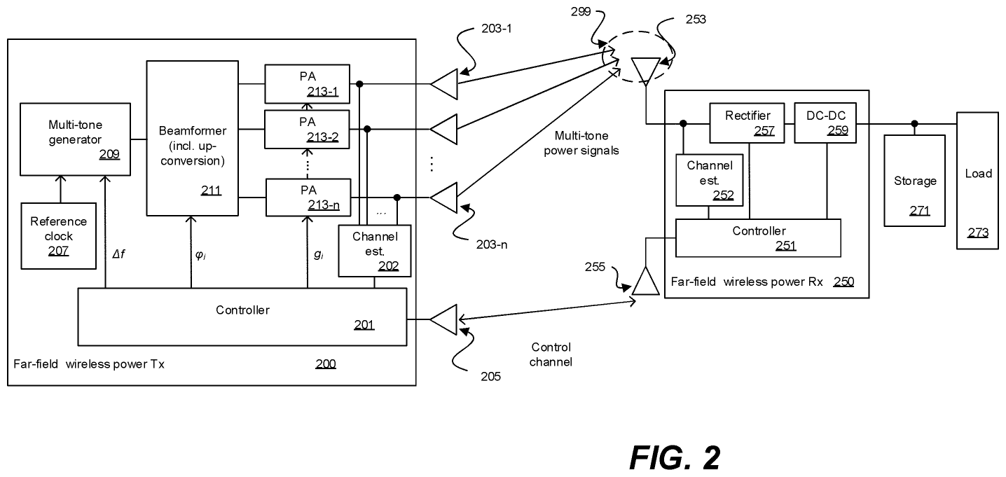

FIG. 2 is a block diagram for one embodiment of a far-field wireless power TX 200 and a far-field wireless power RX 250. Considering the receiver first, the shown embodiment of a far-field wireless power RX 250 includes a power signal receiving antenna 253 connected to a rectifier circuit 257 that is in turn connected to DC-DC converter 259. The antenna 253 is configured to receive an RF waveform, which can then be rectified by the rectifier circuit 257 into a DC voltage level for supplying a storage element 271 such as a battery, drive a load 273, or both, depending on the embodiment. The DC-DC converter 259 can shift the level of the DC output from the rectifier circuit 257, if needed, for supply the storage element 271 and load 273. A number of antenna rectification circuits and DC-DC converter designs are known and can be used in the embodiments described here. A controller 251 is connected to the rectifier circuit 257 and the DC-DC converter 259 to control their operation. In FIG. 2 the far-field wireless power receiver 250 also includes a control channel antenna 255 by which the far-field wireless power receiver 250 can exchange control signal with the far-field wireless power transmitter 200, such as can be used for exchanging location information and other control data. In the shown embodiment, the antenna 255 provides a separate channel for the exchange of control signals, but in other embodiments the control signals can be in-band and encoded in the power signals as received at antenna 253.

On the transmitter side, the far-field wireless power TX 200 includes a controller 201 connected to a control channel antenna 205 by which it can send and receive the control signals exchanged with the far-field wireless power receiver 250. For embodiments using an in-channel exchange of control signals, the control signals can be encoded into the power transmission signals. The one or more control circuits of controller 201 are also connected to the power signal generating elements of the far-field wireless power TX 200. The controller 201 can include one or more control circuits and perform the functions described in the following through hardware, software, firmware and various combinations of these, depending on the embodiment.

The power signal generating elements of the far-field wireless power Tx 200 include a reference clock source 207, multi-tone generator 209, beamformer 211, and power amplifiers 213-1 to 213-n. The reference clock source 207 generates a base signal from which the multi-tone signal can be generated by the multi-tone generator 209. In FIG. 2, the reference clock source 207 is shown to generate a lower frequency signal that can then be upconverted to a signal in the RF range at the frequency center f_{c} of the set of multi-tone signals, but in other embodiments the reference clock source 207 can provide another base frequency from which the multi-tone signal is generated, such as the frequency center f_{c} or the frequency of the lowest tone of the multi-tone signal.

The multi-tone generator 209 receives the base frequency refence clock signal from the reference clock source 207 and generates a multi-tone signal and, in some embodiments, upconverts the multi-tone signal to be at or near the frequency center f_{c} that can be in the RF range, for example. As described in more detail below, the different tones of the multi-tone power signal are spaced by a frequency difference of M, where, depending on the embodiment, the value of Δf can be a fixed value or a variable value that can be determined and provided by the one or more controller circuits of the controller 201.

The multi-tone signal from the multi-tone generator 209 is received at the beamformer 211 that generates multiple copies (n copies in this example) of the multi-tone power signal and introduces relative delays, or equivalently phases φᵢ, into the copies and, in some embodiments, amplitude differences into the copies. Although represented as separate blocks in FIG. 2, the multi-tone signal generation and beamforming can be part of a unified process, so that in some embodiments the multi-tone generator 209 can be considered part of the beamformer 211. The relative delays or phases φᵢ are determined by one or more control circuits of the controller so that when each of the n signals are transmitted from a corresponding power signal antenna 203-1 to 203-n they will constructively interfere to form a beam in a region 299 and destructively interfere away from the region 299. The amplitude and phase can be determined per antenna and per tone. Depending on the embodiment, not only can the multiple copies of multi-tone signal have phase and amplitude distribution, but within each copy of the multi-tone signal the phase and amplitude of each tone can be different too depending on the beam forming algorithm.

Before providing the multi-tone power signals to the power amplifiers PA 213-1 to 213-n, the signal can be upconverted to have a frequency center f_{c} in the RF range, for example. In FIG. 2, the upconverter is represented as included as part of the beamformer 211, but in many implementations this will a separate upconverter block. The individual power signals from the beamformer 213 are here provided through a corresponding one of the power amplifiers PA 213-1 to 213-n, where the gain gᵢ of each power amplifier can be determined by the controller 201 and be the same for all of the beamforming signals or differ from signal to signal if the signals to are to have differing relative amplitudes. The beamformer 211 (including upconverter) can be implemented as one or more circuits and in analog, digital, or mixed embodiments through hardware, software, firmware, or various combinations of these. Additionally, although shown as separate blocks in FIG. 2, the beamformer 211 can be fully or partially part of the one or more control circuits of the controller 201.

The location of the region 299 can be determined based on control signals exchanged between the far-field wireless power Tx 200 and the far-field wireless power Rx 250. One set of techniques for determining the relative locations of the far-field wireless power Tx 200 and the far-field wireless power Rx 250 and determining the beamforming parameters is through channel estimation, where, depending on the embodiment, this can be performed on the far-field wireless power Tx 200, the far-field wireless power Rx 250, or by a combination of the two. The channel estimation process can be performed initially before transmitting the wireless power signals to initial determination the relative delays or phases φᵢ, but can be updated one or more times to improve accuracy of the beam.

For embodiments using channel estimation, one or both of a channel estimator 202 in the far-field wireless power Tx 200 and a channel estimator 252 in the far-field wireless power Rx 250 can be included, where one or a combination of both of channel estimator 202 and channel estimator 252 can be involved in the process. In the embodiment of FIG. 2 the far-field wireless power Tx 200, channel estimator 202 is connected between the power signal antenna 203-1 to 203-n and controller 201. Although not shown in FIG. 2, a set of switches can be included between the channel estimator 202 and the power amplifiers PA 213-1 to 213-n so that the power signal antenna 203-1 to 203-n can be selectively routed to the channel estimator 202 or the power amplifiers PA 213-1 to 213-n. For the far-field wireless power Rx 250, channel estimator 252 is connected between the power signal antenna 253 and controller 251. Although FIG. 2 shows the channel estimator 202 and the channel estimator 252 as separate from respective controller 201 and 251, in some embodiments the estimators may partially or wholly be part of the respective controllers. As with other elements of the far-field wireless power Tx 200 and the far-field wireless power Rx 250, the channel estimator 202 and the channel estimator 252 can be implemented in hardware, software, firmware, or various combination of these.

In a first set of embodiments for channel estimation, the far-field wireless power Rx 250 sends a “beacon” signal through the power signal antenna 253 or, in alternate embodiments, control channel antenna 255. On the side of the far-field wireless power Tx 200, each one of the power signal antenna 203-1-203-n listens to the beacon signal and, based on the received signal, channel estimation is made between each power signal antenna 203-1-203-n on the transmitter's side and the power signal antenna 253 on the receiver's side. Then beam forming is completed based on the channel estimation result for power transfer.

In another set of embodiments for channel estimation, the far-field wireless power Tx 200 can individually send a beacon signal one by one from the power signal antenna 203-1-203-n. The far-field wireless power Rx 250 continues to listen with power signal antenna 253 and processes the received signals. The channel estimation is performed on the receiver side by the channel estimator 252. The calculated channel estimation information is sent from far-field wireless power Rx 250 to the far-field wireless power Tx 200 over the in-band channel between the power signal antenna 253 and the power signal antenna 203-1-203-n or control channel between the control channel antenna 255 and the control channel antenna 205. Then the far-field wireless power Tx 200 can then calculate the beam forming parameters and apply them for power transfer.

As discussed above, although far-field wireless power transfer is considered the “holy grail” of wireless power technologies, a significant drawback of the current methods of beamforming is that while it sends energy from the transmitter to the receiver by creating a field or vibration at the receiver location, it also creates strong fields along the path between the transmitter and the receiver. This field at locations along the path is usually stronger than the field at the receiver location, which creates safety and interference concerns.

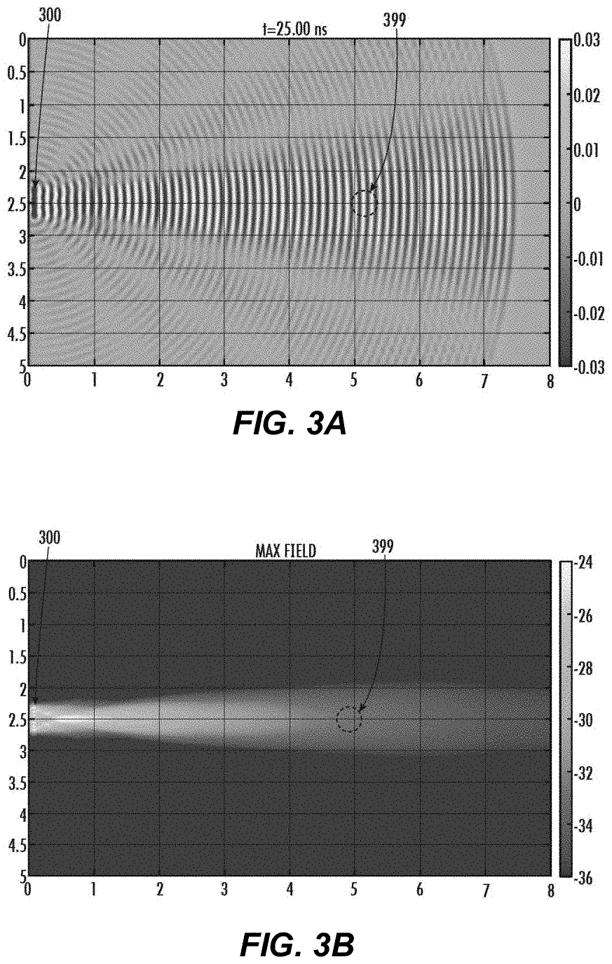

In an RF far-field power transfer embodiment, such as illustrated by FIG. 2, although the field at the region 299 where the power signal receiving antenna 253 of far-field wireless power Rx 250 is located may not exceed RF safety (RF exposure) limits, along the path in between the far-field wireless power Tx 250 and the far-field wireless power RX 250, the field strength may be higher than the limits. This can be illustrated by FIGS. 3A and 3B.

FIGS. 3A and 3B illustrate a simulation of a 2D field distribution from an 8 antenna element array transmitting RF signals at the same single frequency, equal amplitude and in phase. In each FIGS. 3A and 3B, a far-field wireless power Tx 300 is located at left and a region 399 for an intended receiver is at two-thirds the way across each of the figures. The simulation represented in FIGS. 3A and 3B is for a beamforming transmitter embodiment having an 8 element array of antennas. In each of FIGS. 3A and 3B the horizontal axis is the distance from the transmitter, and the vertical axis is the distance to the left or right of the transmitter, where the units along both axes could be meters, for example. FIG. 3A illustrates the wave fronts propagating to the left form the far-field wireless power Tx 300, exhibiting constructive and destructive interference and where lighter colored region represents a higher field strength.

The maximum field of each location (over time) is plotted in FIG. 3B, where the lighter the color the stronger the field. As can be seen in FIG. 3B, assuming the intended receiver is in the center of the domain at region 399, the field closer to the far-field wireless power Tx 300 could be much stronger than the field at a receiver location in region 399. This phenomenon is one of the key roadblocks for far-field wireless power transfer to get regulatory approval, to get public's acceptance and ultimately deliver great user experience.

One approach to mitigate this issue is to define an operating zone, where a receiver would be placed, and a keep out zone in highest field value area in the vicinity of the transmitter. The system could then employ motion sensors to detect if a user were approaching the keep out zone near the transmitter and turn off power for the transmission accordingly, which would significantly limit the user experience. As an alternate approach, the following presents embodiments that leverage the time domain characteristics of a multi-tone signal along with a spatial configuration of the transmitter antenna arrays, to deliver beamforming beyond the space domain, which would localize the field better at a receiver without creating stronger field values between the transmitter and receiver.

More specifically, the embodiments described in the following employ multi-tone signals for power transfer and leverage the time domain characteristics of such signals to localize the strongest field in a designated location in space through strategic placement of wireless power transmitters and optimized beamforming techniques. The antenna array size, bandwidth and frequency spacing between the multi-tone signals can be strategically selected for a certain operating environment to realize this localized field, which will in turn lead to a far-field wireless power transfer solution with significantly less RF exposure risk and regulatory concerns.

A multi-tone signal can be generally described as:

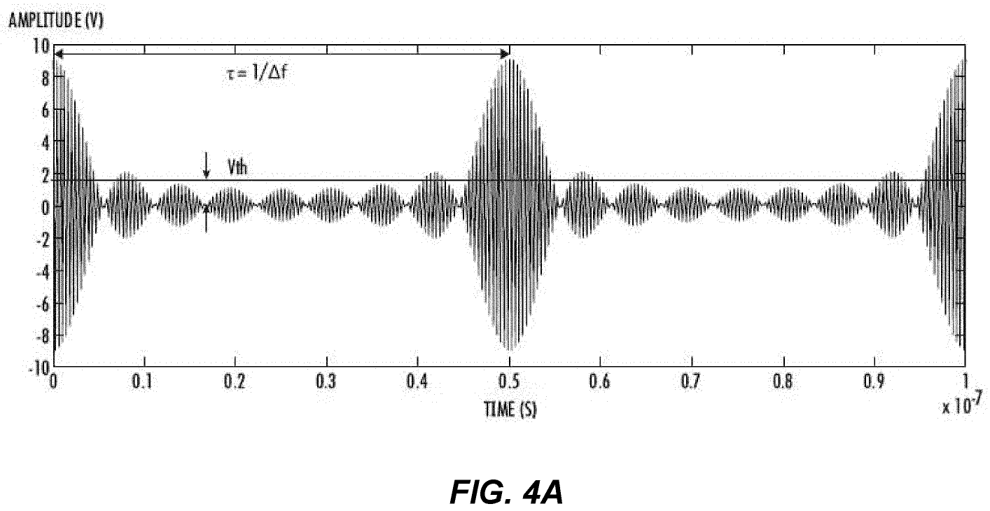

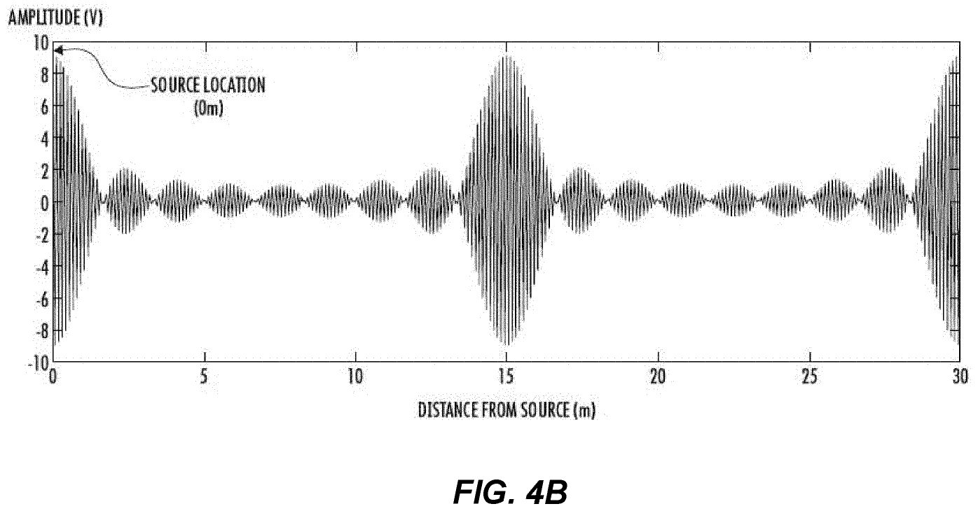

s(t)=Σₙ₌₁^{N}^{ₜ}aₙ cos(2πfₙt+Øₙ),

where the Nₜ is the number of tones, aₙ is the amplitude of the nth tone at frequency fₙ, and Øₙ is the phase of the nth tone. When the different tones have same amplitude (aₙ=const.) and are in phase (Øₙ=const.), a high PAPR (peak to average power ratio) signal is constructed. When the frequency of tones are equally spaced by a frequency difference Δ_{f}, the expression can be simplified as:

$$s ( t ) = {a}_{m} \frac{sin ( π {N}_{t} Δ ft )}{sin ( Δ f π t )} cos ( 2 π {f}_{c} t ) ,$$

where f_{c} is the center frequency of the multiple tones. This multi-tone signal has an envelope that follows a period of τ=1/Δf, as is illustrated in FIG. 4A

FIG. 4A shows the time domain waveform of an embodiment of a multi-tone signal consisting of 8 equally spaced, in phase tones centered at f_{c}=2.45 GHz with a Δf=20 MHz spacing between the tones. As can be seen in FIG. 4A, at time 0, all 8 tones are in phase, and the amplitude of the combined multi-tone signal is highest (8× of each tone), while as time progresses, the 8 tones start run out of phase such that the amplitude of the waveform reduces significantly. This continues until at τ=1/Δ_{f} (i.e. 50 ns), all tones are combined in phase again, and another peak in field appears. Essentially energy is focused in time domain using multi-tone signal to the periodic peaks every 1/Δf, such that the combined field could exceed a receiver's rectifier (such as rectifier 257 of FIG. 2) diode's turn on voltage (Vth) to deliver power to load.

In the embodiments presented here, the field distribution of the multi-tone signal in the space domain is used to realize a localized “hot spot” for power transfer. For example, the same plot as in FIG. 4A can be depicted in the space domain with the x-axis defined as the distance from the source.

FIG. 4B is a plot showing at one instance of time the field established by a multi-tone signal over points along the propagation path different distances from the source (attenuation of wave propagation is omitted here for simplicity). As can be seen in FIG. 4B, as the multi-tone signal propagates away from the source, it carries the time domain signature through space, where every cτ (c represent the speed of light) there is a local peak of field in space. As these periodic peaks move away from the source, passing through each point along the propagating path while maintaining the distances between peaks.

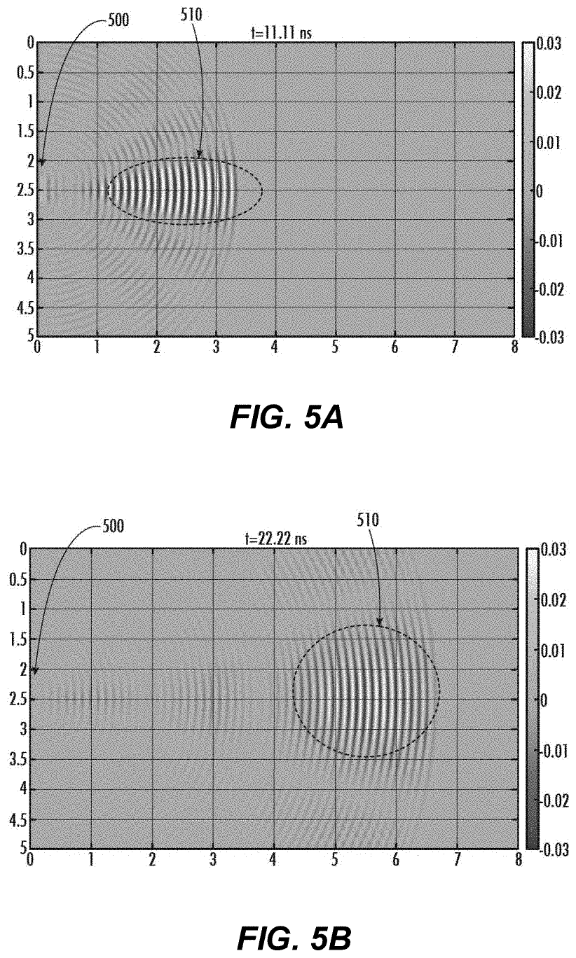

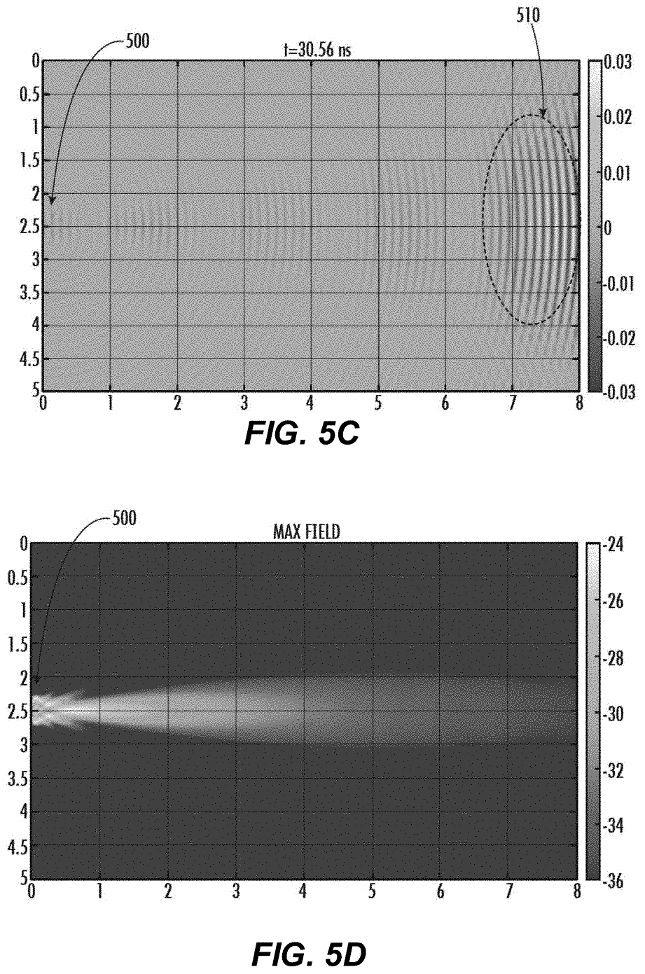

FIGS. 5A-5C show a 2D simulation of wave propagation from an 8 antenna beamforming transmitter 500 in a 5 m by 8 m region as the multi-tone signal propagates from the source location to the right side, as it carries the time domain characteristics through the domain. The circled higher field regions 510 are represented in the lighter color and propagate to the right as shown in the sequence of images.

FIG. 5D illustrates the peak field strength for the same simulation as represented in FIGS. 5A-5C. As shown in the peak field strength plot of FIG. 5D, similarly to the single frequency case as illustrated in FIG. 3B, the locations closer to the source still have stronger (lighter in color) field levels than locations on the propagation path but further away from the source. As a result, in this configuration, embodiments employing a multi-tone signal from a single source alone may not fully eliminate the emission/RF exposure problem outlined previously. Embodiments presented here introduce a second transmitter array at a different location noncontiguous with the first transmitter array, and which also transmit multi-tone charging signal to achieve a localized strong field value.

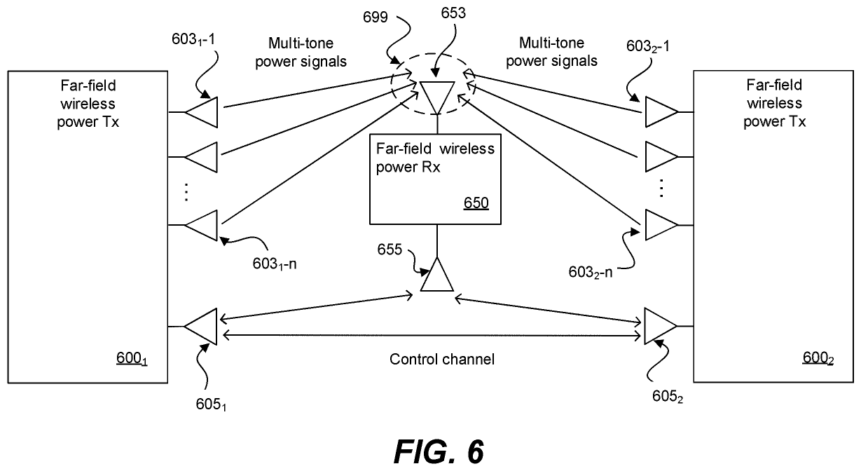

FIG. 6 illustrates an embodiment that uses two beamforming antenna arrays to transmit power to a far-field wireless power receiver. Depending on the embodiment, these two arrays can be two antenna sub-arrays of the same far field wireless power transmitter, or the antenna arrays of two separate transmitters. The two arrays, or subarrays, of antenna can carry signals derived from the same clock source to maintain coherence. This is more readily achieved if sub-arrays from same transmitter are used. When two transmitters are used, the signals from their respective arrays should be derived from synchronized clock signals though the exchange of control signals. FIG. 6 illustrates an embodiment with two transmitters, but, more generally, these can be considered as two synchronized arrays of antenna, whether as sub-arrays of a single transmitter or from two separate transmitters.

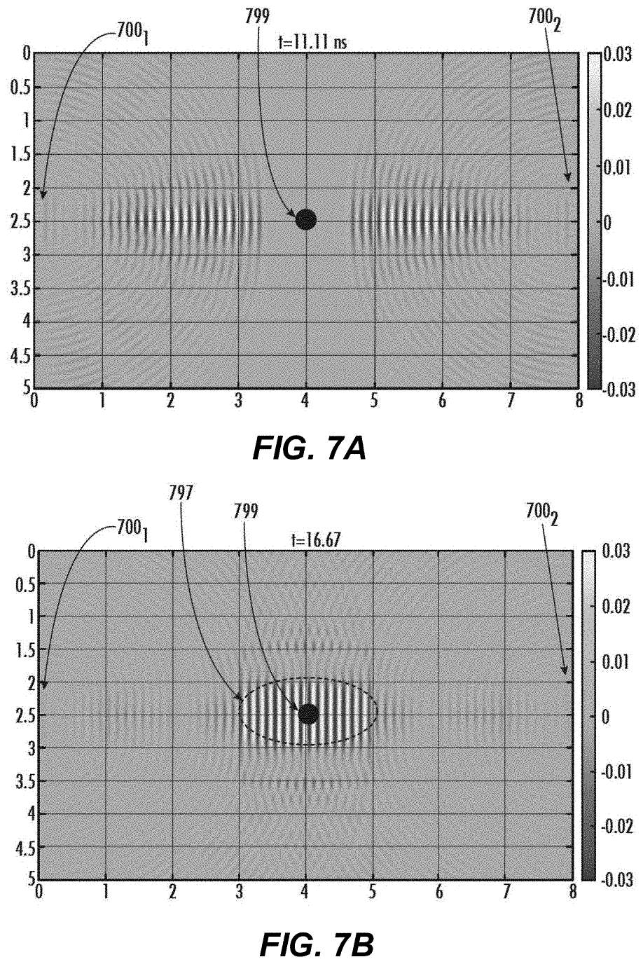

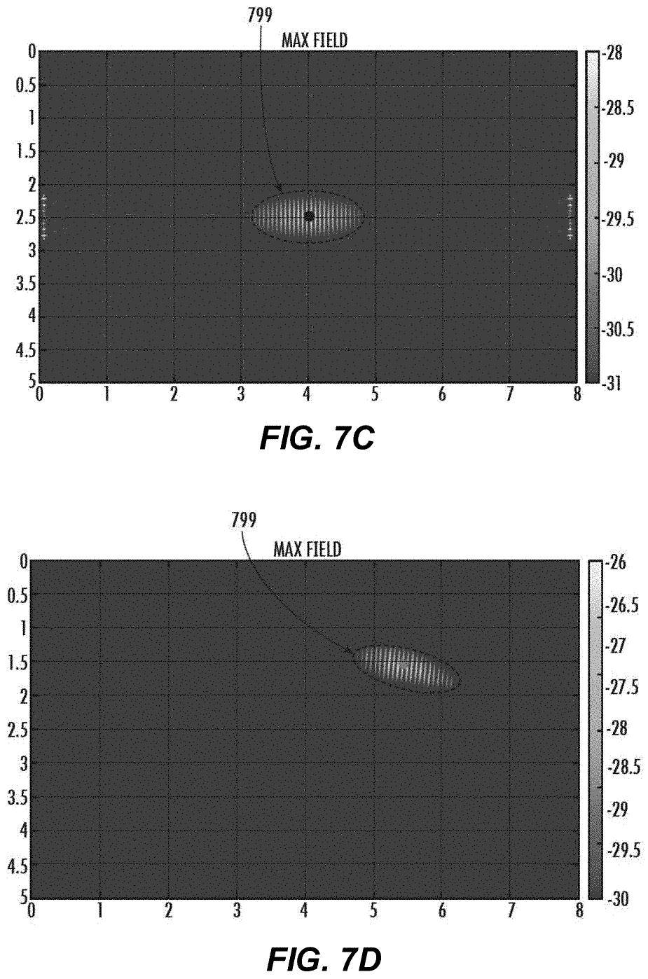

Considering the two transmitter embodiment, each of the two beamforming far-field beamformer wireless power transmitters 600₁ and 600₂ can be as illustrated by the embodiment of the beamforming far-field wireless power TX 300 of FIG. 3 and include an array of antennas (603₁-1 to 603₁-n and 603₂-1 to 603₂-n) to transmit the multi-tone power signal and arranged to form a beam in the region 699. For example, in the embodiments used in the 2D simulation illustrated in FIGS. 7A-7D discussed below, n=8, but other values can be used. Generally, more antennas provide a better defined beam, but at the cost of more power and complexity. The two far-field beamforming wireless power transmitters 600₁ and 600₂ transmit the multi-tone power signal so that their beams are formed in the region 699 and constructively interfere to form a “hot spot” in the region 699. As noted above, although the embodiment of FIG. 6 shows two far-field beamforming wireless power transmitters 600₁ and 600₂ each with its own array of antennas (603₁-1 to 603₁-n and 603₂-1 to 603₂-n) to transmit the multi-tone power signal, in other embodiments the two or more sets of antenna can belong to a single transmitter circuit and be considered sub-arrays of the larger array, but where these sub-arrays would be located apart and each receiving a corresponding set multi-tone power signals for the target region 699.

A far-field wireless power receiver 650 is located so that the antenna 653 for receiving the multi-tone power signal is located in the “hot spot” of region 699. The far-field wireless power receiver 650 of FIG. 6 can be as described above for the embodiment 250 of FIG. 2. The far-field wireless power receiver 650 and the far-field beamforming wireless power transmitters 600₁ and 600₂ can include respective control channel antennas 655, 605₁, and 605₂ to exchange information to use in establishing the relative delays of the multiple beamforming signals from the far-field beamforming wireless power transmitters 600₁ and 600₂ so that the beams are formed and constructively interfere in the region 699. In one embodiment, the control signals exchanged between the two far-field beamforming wireless power transmitters 600₁ and 600₂ can be ultrasound signals used to maintain coherence between the two sets of beamforming signals. In other embodiments, some or all of the control signals can be in-band and embedded in the power signal.

FIGS. 7A and 7B illustrate 2D simulations similar to FIGS. 5A-5C, but with two far-field beamforming wireless power transmitters 700₁ and 700₂ or sub-arrays from the same transmitter transmitting multi-tone power signals to either side of the region. As shown in FIGS. 7A and 7B, two 8 antenna element arrays of two far-field beamforming wireless power transmitters 700₁ and 700₂ are placed on opposite side of the 5 m×8 m free space domain, and both antenna arrays are synchronized to transmit the same 8 tone signal. FIG. 7A shows the wave fronts nearer the antenna and FIG. 7B shows a later time after the multi-tone signals have propagated through the center of the free space domain. Due to the high PAPR nature of the multi-tone signals, the wave fronts have the highest field amplitude. As the power signals propagate towards each other, they start to interfere and create local field peaks, where the peaks generated from the two wave fronts are the strongest. As a result, a local field “hot spot” 797 in space is created, as is also shown in the maximum field plot of FIG. 7C.

FIG. 7C is a peak field strength similar to FIG. 5D, but for the same simulation as represented in FIGS. 7A and 7B where two far-field beamforming wireless power transmitters 700₁ and 700₂ transmitting multi-tone power signals to either side of the region. The field strength in the “hot spot” 797 can be optimized so that it is the strongest in the domain and even has higher amplitude than the source antenna locations or the propagation path between source and the “hot spot” 797. This phenomenon offers significant advantage over conventional far-field wireless power transfer solutions by localizing the peak of field in the vicinity of the wireless power receiver only.

The combination of the two beamforming signals and use of multi-tone power signals provide the localized “hot spot” at region 799. If two beamforming signals from the far-field beamforming wireless power transmitters or sub-arrays 600₁ and 600₂ instead use signal tone power signals, the wave fronts continue to travel pass each other to continuously interfere with each other along the propagation path. As a result, along the entire propagation path the field is relatively strong and evenly distributed with peak field occurring between the source and the intended receiver location. Because of this, a single tone signal does not have the field localization characteristics illustrated in FIG. 7C.

With use of a multi-tone signal in this configuration, the localized “hot spot” can be realized virtually anywhere in the domain through applying different beam steering and delay between the two transmit arrays. An intended receiver may be off center from the two transmitters, so that a relative delay can be applied to the one of the far-field beamforming wireless power transmitters such that the “hot spot” occurs at the intended receiver location. Different beam steering between the two far-field beamforming wireless power transmitters 600₁ and 600₂ antenna arrays in combination with proper relative between the two transmitters delay allows the “hot spot” to be created in arbitrary positions.

FIG. 7D is a plot of peak field strength for the same simulation of FIG. 7C, but where the two multi-tone waves of the power are transmitted with different delay and beam steering angle to achieve a “hot spot” 799 off centerlines. The use of beam steering for each of the two far-field beamforming wireless power transmitters 600₁ and 600₂ and the introduction of relative delays or, equivalently, phases between the two transmitters' multi-tone power signals allows the “hot spot” 799 to located at a receiver placed at a selected location in the region. By such use of beam steering and relative delays between the transmitters, a number of alternate embodiments are possible, where the two or more non-contiguous transmitter antenna arrays could be arranged differently from the examples presented so far, such as orthogonal, co-planar, and so on.

As described above, the combination of the multi-tone signal with a certain frequency spacing Δf between tones and the array configuration enables the creation of local “hot spot” of wireless power signal such the strongest field is only created in the vicinity of the intended receiver. A rule of thumb for the Δf selection is that the corresponding wavelength of the multi-tone signal λ=c/Δf is greater than the longest dimension of the domain. For example, in the above simulation examples, the multi-tone signal has Δf=20 MHz, which correspond to an equivalent wavelength λ=15 m, while the longest dimension of the domain is <10 m<λ. When this condition is met, there is only one “hot spot” created in the domain. Otherwise, for the same 5 m×8 m domain size, a multi-tone signal with Δf=60 MHz, for example, would allow more than one time domain peak simultaneously appear in the domain, which could create more than one “hot spot”. The techniques presented here are quite useful for use with in-door far-field wireless power transfer to sensors and mobile devices where an average room size is usually small enough to only allow one “hot spot” in the room. They may also be used, for example, for simultaneous power and data transfer by mobile communication base stations.

In real world implementations of the embodiments presented here, the domain boundaries may be reflective and there may be obstruction along the signal propagation path. In these situation, the channel is considered as a fading channel, and in some embodiments more complex beam forming techniques can be applied per antenna and per frequency tone so that at the intended receiver location, the multi-tone signal can be re-constructed as combination of multiple reflections. However as long as the above multi-tone signal and TX antenna configurations are met, a single “hot spot” is expected in the domain.

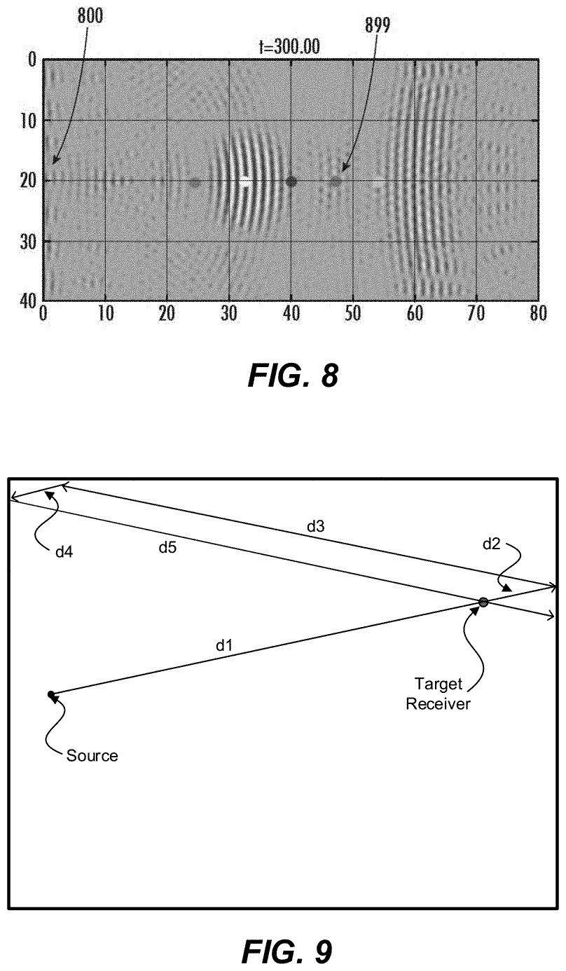

FIG. 8 illustrates an environment where strong reflection occurs at the boundary of the domain and where, in some embodiments, the reflection from the boundary can be utilized to form localized “hot spots”. In the example of FIG. 8, a domain with a reflecting wall on the right side is shown, where an 8 element antenna array 800 is sending an 8 tone signal toward the right. As the multi-tone wave front propagates from the antenna array, a multi-tone waveform is observed. Once the wave-front hits the reflecting boundary on right, it is reflected back, and the reflected signal start to interfere with the next peak sent from the source toward the right. The interference pattern creates the highest field at a location 899 along the propagating path that has a distance d to reflecting wall of d=c/2Δf.

This example shows that the technique of creating local “hot spot” can be realized by a single contiguous antenna array as source, but where the domain is reflective such that multiple peaks from the same multi-tone signal transmission could be reaching the same destination location with different number of reflections. As the path length distance of the different reflection paths is roughly c/Δf or integer multiples of c/Δf. In some embodiments the controller of the far-field power transmission circuit can select the Δf value as part of the determination of parameters in the beam forming process in order to form the “hot spot” in the desired location.

FIG. 9 illustrates a general case in which a domain with strong reflecting boundaries (such as a room with metal walls) has multiple reflections of the same power signal. In some embodiments, the beam can be formed toward the target receiver location, as the wave front passes the target receiver, it is bounced back by the reflecting wall with some attenuation. The reflection happens a few times within the domain until on the third bounce of the same signal the wave front passes the target receiver again. The difference in distance travelled by the save signal reaching the target through direct and multiple reflection paths can be written as:

Δd=d₂+d₃+d₄+d₅.

In phase combinations of multiple peaks of the same multi-tone signal will happen when Δd=c/Δf or a multiple thereof. For a fixed source and receiver location, the construction of the multi-tone signal can be optimized such that the above condition is met, where a localized “hot spot” can be achieved with a single source array and a strong reflection environment. The use of multi-tone signal provides us with this additional variable Δf to dynamically adjust for different wireless power transfer environment and scenarios.

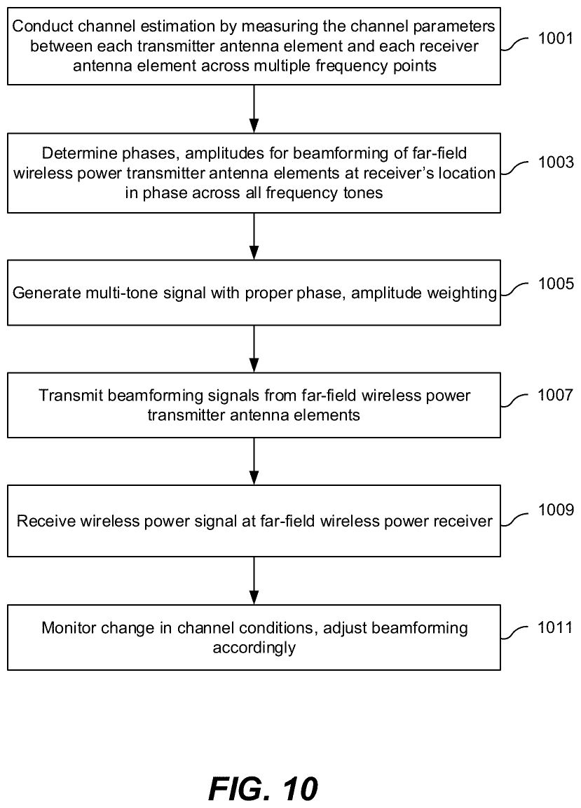

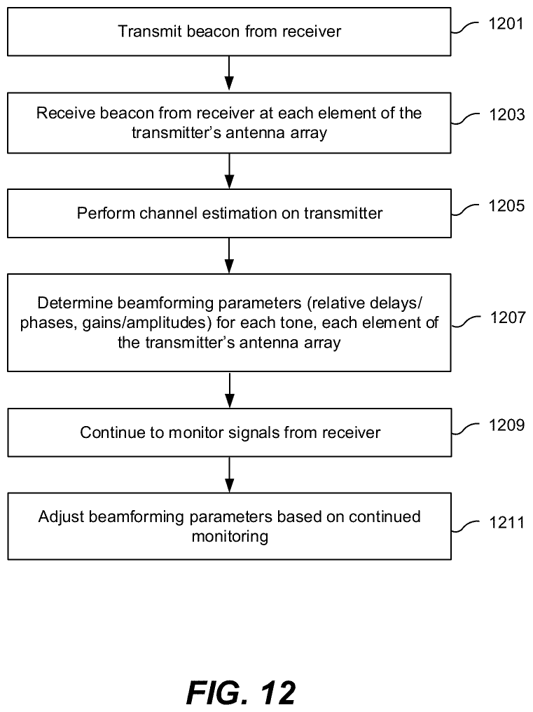

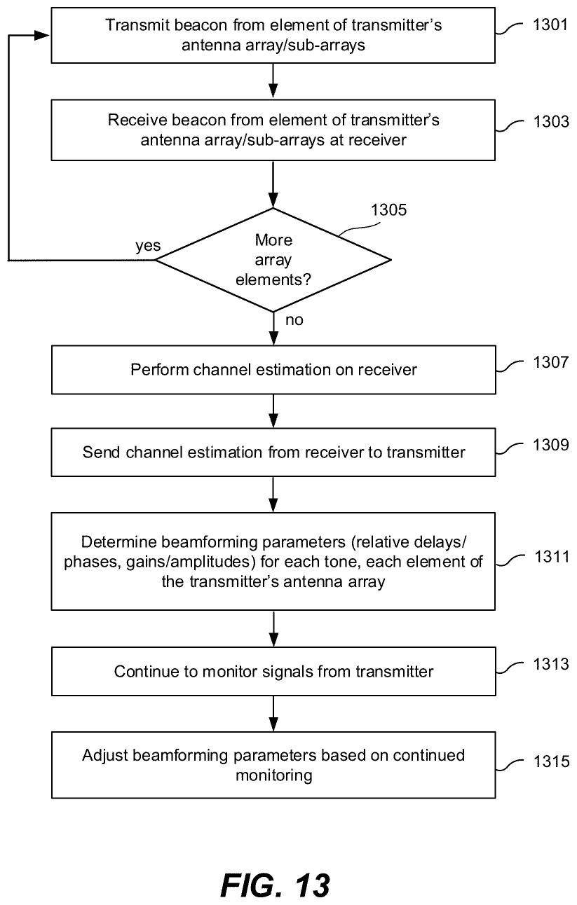

FIG. 10 is a flowchart of one embodiment of a process of operating a far-field wireless power transmitter using a multi-tone power signal. FIG. 10 looks at a single transmitter embodiment, as in FIG. 2. Beginning at 1001 and referring back to FIG. 2, a channel estimation is conducted by channel estimator 202 and/or channel estimator 252 by measuring the channel parameters between each of the power signal antenna 203-1 to 203-n of the far-field wireless power TX 200 and the power signal antenna 253 of the far-field wireless power RX 250. From the channel estimation, the amplitudes and phases for beamforming can be determined at 1003 such that the signals from the transmitting power signal antenna 203-1 to 203-n arrive at the receiver's power signal antenna 253 location in phase across all frequency tones. Using the beamforming parameters determined at 1003, at 1005 a multi-tone power signal is generated with the proper phase and amplitude weighting. More detail on 1001 and 1003 is given below with respect to FIGS. 12 and 13.

The set of beamforming signals are then amplified and transmitted from the array of antenna 203-1 to 203-n at 1007, forming a beam at the region 299. The far-field wireless RX 250 receives the multi-tone power signal at antenna 253 at 1009, which it can use to charge the storage 271, drive the load 273, or both. In some embodiments, the far-field wireless RX 250, far-field wireless power TX 200, or both can continue to monitor the multi-tone power signal during the power transfer process and exchange control signals through the control channel to adjust the beamforming parameters if needed at step 1011.

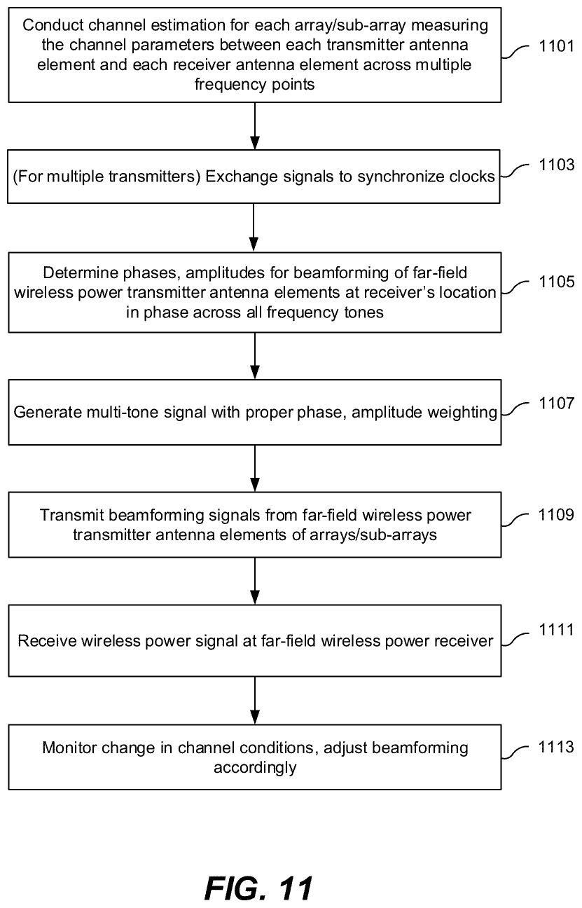

FIG. 11 is a flowchart of one embodiment of a process of operating far-field wireless power transmitters using a multi-tone power signals from multiple transmitter antenna arrays, whether multiple sub-arrays of a single transmitter or in a multiple transmitter embodiment as in FIG. 6. The process of FIG. 11 largely follows that of FIG. 10, but a channel estimation is performed for the multiple transmitter antenna arrays and, if multiple transmitters are used (rather than multiple sub-arrays of a single transmitter), the transmitters will need to coordinate their beamforming so that their individual beams are coherent at the receiver location.

Beginning at 1101 and referring back to FIG. 2, a channel estimation is conducted by channel estimator 202 on far-field wireless power transmitter 600₁, and far-field wireless power transmitter 600₂, and/or channel estimator 252 by measuring the channel parameters between each of the power signal antenna arrays or sub-arrays 603₁-1 to 603₁-n and the power signal antenna 653 of the far-field wireless power RX 650 and also between each of the power signal antenna arrays or sub-arrays 603₂-1 to 603₂-n and the power signal antenna 653 of the far-field wireless power RX 650. If the signal antenna arrays 603₁-1 to 603₁-n and 603₂-1 to 603₂-n belong to different transmitters, rather than being sub-arrays of a single transmitter, then at 1103 the transmitters exchange signals to synchronize their clock signals, if this has not be done previously. From the channel estimation of 1101 and synchronization of 1103, at 1105 the amplitudes and phases for beamforming can be determined such that the signals from the transmitting power signal antenna arrays 603₁-1 to 603₁-n and 603₂-1 to 603₂-n and arrive at the receiver's power signal antenna 653 location in phase across all frequency tones. Using the beamforming parameters determined at 1105, at 1107 a multi-tone power signal is generated with the proper phase and amplitude weighting.

The set of beamforming signals are then amplified and transmitted from the arrays or sub-arrays of antenna 603₁-1 to 603₁-n and 603₂-1 to 603₂-n at 1109, forming a beam at the region 699. The far-field wireless RX 650 receives the multi-tone power signal at antenna 653 at 1111, which it can use to charge the storage 271, drive the load 273, or both. In some embodiments, the far-field wireless receiver and/or far-field wireless power transmitters can continue to monitor the multi-tone power signal during the power transfer process and exchange control signals through the control channel to adjust the beamforming parameters if needed at step 1113.

FIGS. 12 and 13 are respectively flowcharts of embodiments for receiver initiated and transmitter initiated channel estimation. In this regard, FIGS. 12 and 13 provide more detail on 1001 and 1011 of FIG. 10 and on 1101 and 1113 of FIG. 11. A distinction between the two cases is that for a receiver initiated beacon, all of the transmitter antennas can be listening at the same time and collect data to calculate channel estimation at the same time, but for a transmitter initiated channel estimation, the transmitter antennas will transmit beacon signals one by one for the receiver to process individual channel information.

Beginning at 1201 of FIG. 12, the far-field wireless power receiver transmits a beacon signal from its power signal antenna (e.g., 653 or 253). All of the individual elements of the antenna array or sub-arrays (203-1 to 203-n, 603₁-1 to 603₁-n, and 603₂-1 to 603₂-n) can listen at the same time, receiving the beacon and collecting data at 1203. Based upon the received beacon, at 1205 a channel estimation is performed. The channel estimation can be performed by the channel estimator 202. Based upon the channel estimation, at 1207 the controller 201 can determine the beamforming parameters (the relative delays/phases, gains/amplitudes) used by the beamformer 211. Once all of the parameters for the set multi-tone power signals, the power signals can be transmitted. The far-field wireless power TX 200, 600₁ or 600₂ can continue to monitor signals from the far-field wireless power RX 250 or 650 by each component of the antenna array or sub-arrays at 1209, where the monitored signals can be a beacon or in-band communication signals. Based on the monitoring, the beamforming parameters can be adjusted at 1211, where this can be a one-time adjustment or on-going process while the power signals continue to be transmitted.

The transmitter initiated channel estimation begins at 1301 with a first element of the antenna arrays or sub-arrays (203-1 to 203-n, 603₁-1 to 603₁-n, and 603₂-1 to 603₂-n) transmitting a beacon, which is received at the power signal antenna (e.g., 653 or 253) on the receiver at 1303. 1305 determines if there are more beacons from other elements of the antenna arrays or sub-arrays (203-1 to 203-n, 603₁-1 to 603₁-n, and 603₂-1 to 603₂-n) and, if so, the flow loops back to 1301 for the next beacon. Once all of the beacons from the transmitter are received, at 1305 the flow continues on to 1307. At 1307, based upon the received beacon, a channel estimation is performed. The channel estimation can be performed by the channel estimator 252. The result of the channel estimation can be sent to the far field wireless power over the control channel at 1309. Based upon the channel estimation information, at 1311 the controller 201 can determine the beamforming parameters (the relative delays/phases, gains/amplitudes) used by the beamformer 211. Once all of the parameters for the set multi-tone power signals, the power signals can be transmitted. The far-field wireless power RX 250 or 650 can continue to monitor signals from the far-field wireless power TX 200, 600₁ or 600₂ by each component of the antenna array or sub-arrays at 1313. Based on the monitoring, the beamforming parameters can be adjusted at 1315, where this can be a one-time adjustment or on-going process while the power signals continue to be transmitted.

Certain embodiments of the present technology described herein, such as the processes described above for a controller of a far-field wireless power transmitter (e.g., controller 201 of far-field wireless power TX 200, 600₁ or 600₂) or controller on a far-field wireless power receiver (e.g., controller 251 of far-field wireless power RX 250 or 650) can be implemented using hardware, software, or a combination of both hardware and software. The software used can be stored on one or more of the processor readable storage devices described above to program one or more of the processors to perform the functions described herein. The processor readable storage devices can include computer readable media such as volatile and non-volatile media, removable and non-removable media. By way of example, and not limitation, computer readable media may comprise computer readable storage media and communication media. Computer readable storage media may be implemented in any method or technology for storage of information such as computer readable instructions, data structures, program modules or other data. Examples of computer readable storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. A computer readable medium or media does not include propagated, modulated, or transitory signals.

Communication media typically embodies computer readable instructions, data structures, program modules or other data in a propagated, modulated or transitory data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as RF and other wireless media. Combinations of any of the above are also included within the scope of computer readable media.

In alternative embodiments, some or all of the software can be replaced by dedicated hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), special purpose computers, etc. In one embodiment, software (stored on a storage device) implementing one or more embodiments is used to program one or more processors. The one or more processors can be in communication with one or more computer readable media/storage devices, peripherals and/or communication interfaces.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

The disclosure has been described in conjunction with various embodiments. However, other variations and modifications to the disclosed embodiments can be understood and effected from a study of the drawings, the disclosure, and the appended claims, and such variations and modifications are to be interpreted as being encompassed by the appended claims. In the claims, the word “comprising” does not exclude other elements or steps, and the indefinite article “a” or “an” does not exclude a plurality.

For purposes of this document, it should be noted that the dimensions of the various features depicted in the figures may not necessarily be drawn to scale.

For purposes of this document, reference in the specification to “an embodiment,” “one embodiment,” “some embodiments,” or “another embodiment” may be used to describe different embodiments or the same embodiment.

For purposes of this document, a connection may be a direct connection or an indirect connection (e.g., via one or more other parts). In some cases, when an element is referred to as being connected or coupled to another element, the element may be directly connected to the other element or indirectly connected to the other element via intervening elements. When an element is referred to as being directly connected to another element, then there are no intervening elements between the element and the other element. Two devices are “in communication” if they are directly or indirectly connected so that they can communicate electronic signals between them.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify different objects.

The foregoing detailed description has been presented for purposes of illustration and description. It is not intended to be exhaustive or to limit the subject matter claimed herein to the precise form(s) disclosed. Many modifications and variations are possible in light of the above teachings. The described embodiments were chosen in order to best explain the principles of the disclosed technology and its practical application to thereby enable others skilled in the art to best utilize the technology in various embodiments and with various modifications as are suited to the particular use contemplated. It is intended that the scope be defined by the claims appended hereto.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A wireless power transmitter, comprising:
a beamformer configured to generate a set of beamforming signals by beamforming a multi-tone power signal formed of a plurality of tones with a frequency center and separated by a uniform frequency difference, with the set of beamforming signals carrying a first plurality of multi-tone power signals and configured to form a beam at a first location for power transfer, wherein the first plurality of multi-tone power signals are a set of multiple copies of the multi-tone power signal;
a plurality of power amplifiers, coupled to the beamformer, to amplify the set of beamforming signals of the beamformer; and
a first array of a plurality antennas coupled to the plurality of power amplifiers, each of the antennas of the first array configured to receive and transmit a corresponding multi-tone power signal from a corresponding power amplifier of the plurality of power amplifiers.

2. The wireless power transmitter of claim 1, further comprising one or more control circuits coupled to the beamformer and configured to determine, for each of the first plurality of multi-tone power signals, a corresponding relative phase difference configured to form a beam at the first location.

3. The wireless power transmitter of claim 1, wherein one or more control circuits is further configured to determine, for each of the first plurality of multi-tone power signals, a corresponding relative amplitude difference configured to form a beam at the first location.

4. The wireless power transmitter of claim 1, further comprising one or more control circuits configured to determine a first set of relative delays for the first set of copies of the multi-tone power thereby forming a beam at the first location.

5. The wireless power transmitter of claim 1, further comprising:
a communication antenna; and
one or more control circuits coupled to the communication antenna and configured to exchange control signals with a wireless power receiver over the communication antenna and determine corresponding relative phase differences and relative amplitude differences for the first plurality of multi-tone power signals based upon the control signals exchanged with the wireless power receiver.

6. The wireless power transmitter of claim 1, further comprising:
one or more control circuits coupled to at least one of the plurality antennas and configured to exchange control signals with a wireless power receiver over the at least one of the plurality antennas and determine corresponding relative phase differences and relative amplitude differences for the first plurality of multi-tone power signals based upon the control signals exchanged with the wireless power receiver.

7. The wireless power transmitter of claim 1, further comprising:
a second array of a plurality antennas coupled to the beamformer, wherein the beamformer is further configured to generate a second set of beamforming signals carrying a second plurality of multi-tone power signals each having a corresponding relative phase difference and relative amplitude difference, and wherein each antenna of the second array is configured to receive and transmit power signals including one of the second plurality of multi-tone power signals.

8. The wireless power transmitter of claim 1, further comprising:
a second array of a plurality antennas coupled to the beamformer, wherein the beamformer is further configured to generate a second set of beamforming signals carrying a second plurality of multi-tone power signals, where a first set of relative delays is configured to the set of beamforming signals and a second set relative delays is configured to the second set of beamforming signals so that the beam is formed at the first location; and
wherein each antenna of the second array is configured to receive and transmit power signals including a corresponding multi-tone power signal of the second plurality of multi-tone power signals.

9. The wireless power transmitter of claim 7, further comprising one or more control circuits configured to maintain coherence between the set of beamforming signal and the second set of beamforming signals.

10. The wireless power transmitter of claim 1, wherein the frequency center is in a radio frequency (RF) range and the uniform frequency difference is in a range of 10 MHz to 50 MHz.

11. The wireless power transmitter of claim 1, further comprising one or more control circuits configured to control an energy of the plurality of multi-tone signals in time domain to periodic peaks relative to the uniform frequency difference, such that a combined field exceed a receiver's rectifier diode's turn on voltage.

12. A method of wirelessly transferring power, comprising:
generating a first set of multiple copies of a multi-tone power waveform by a first wireless power transmitter;
introducing, by the first wireless power transmitter, a first set of relative delays into the first set of copies of the multi-tone power waveform, wherein the first set of relative delays are configured to form a beam when the first set of copies of the multi-tone power waveform is transmitted from a first array of antennas; and
transmitting the first set of copies of the multi-tone power waveform with the first set of relative delays from first array.

13. The method of claim 12, further comprising:
introducing by the first wireless power transmitter of a first set of relative amplitude differences into the first set of copies of the multi-tone power waveform, the first set of relative amplitude differences configured to form a beam when the first set of copies of the multi-tone power waveform is transmitted from a first array of antennas.

14. The method of claim 13, wherein generating the first set of multiple copies of the multi-tone power waveform comprises:
generating a multi-tone power waveform of a plurality of tones having a frequency center and separated by a uniform frequency difference; and
duplicating the multi-tone power waveform to generate the first set of multiple copies of the multi-tone power waveform.

15. The method of claim 13, further comprising:
exchanging signals between the first wireless power transmitter and a wireless power receiver; and
determining the first set of relative delays and relative amplitude differences based upon the exchanged signals to form a beam at a location of the wireless power receiver.

16. The method of claim 15, wherein determining the first set of relative delays and relative amplitude differences based upon the exchanged signals includes:
performing a channel estimation by the first wireless power transmitter.

17. The method of claim 15, wherein determining the first set of relative delays and relative amplitude differences based upon the exchanged signals includes:
performing a channel estimation by the wireless power receiver.

18. The method of claim 12,
generating a second set of multiple copies of the multi-tone power waveform;
introducing by a second wireless power transmitter of a second set of relative delays into the second set of copies of the multi-tone power waveform, the second set of relative delays configured to form a beam when the second set of copies of the multi-tone power waveform is transmitted from a second array of antennas, where first set of relative delays and the second set relative delays are configured so that the beam formed by the second set of copies of the multi-tone power waveform when transmitted from the second array of antennas is formed in, and constructively interferes with, a same region as the beam formed by the first set of copies of the multi-tone power waveform when transmitted from the first array of antennas; and
transmitting the second set of copies of the multi-tone power waveform with the introduced second set of relative delays from second array.

19. A wireless power transfer system, comprising
a first wireless power transmitter comprising:
a first signal generation and optimization circuit configured generate a first plurality of multi-tone beam forming waveforms; and
a first antenna array connected to the first signal generation and optimization and configured to receive and transmit the first plurality of multi-tone beam forming waveforms; and
a second wireless power transmitter comprising:
a second signal generation and optimization circuit configured generate a second plurality of multi-tone beam forming waveforms; and
a second antenna array connected to the second signal generation and optimization and configured to receive and transmit the second plurality of multi-tone beam forming waveforms,
wherein first signal generation and optimization circuit and the second signal generation and optimization circuit are further configured to respectively generate the first plurality of multi-tone beam forming waveforms and the second plurality of multi-tone beam forming waveforms to constructively interfere at a region located between the first wireless power transmitter and the second wireless power transmitter.

20. The wireless power transfer system of claim 19, wherein:
the first signal generation and optimization circuit includes a first beamformer configured to introduce a corresponding first delay into each of the first plurality of multi-tone beam forming waveforms; and
the second signal generation and optimization circuit includes a first beamformer configured to introduce a corresponding second delay into each of the second plurality of multi-tone beam forming waveforms.

21. The wireless power transfer system of claim 20, wherein first wireless power transmitter further comprises:
one or more first control circuits connected to the first signal generation and optimization circuit; and
a first communication antenna connected to the one or more first control circuits; and
wherein second wireless power transmitter further comprises:
one or more second control circuits connected to the second signal generation and optimization circuit; and
a second communication antenna connected to the one or more second control circuits,
wherein the one or more first control circuits and the one or more second control circuits are respectively configured exchange signal with a wireless power receiver over the first communication antenna and the second communication antenna and determine the corresponding first delays and second delays based upon signals exchanged with the wireless power receiver such that the region located between the first wireless power transmitter and the second wireless power transmitter corresponds to a location of the wireless power receiver.

22. The wireless power transfer system of claim 21, wherein one or both of the one or more first control circuits and the one or more second control circuits are configured to determine the first delays by a channel estimation.
